(19) United States
(12) Patent Application Publication
(10) Pub. No.: US 2017/0277319 A1
(43) Pub. Date: Sep. 28, 2017

(54) FLEXIBLE DISPLAY DEVICE

(71) Applicant: Lenovo (Beijing) Limited, Beijing (CN)

(72) Inventor: Xiaohua Qiu, Beijing (CN)

(21) Appl. No.: 15/470,434

(22) Filed: Mar. 27, 2017

(30) Foreign Application Priority Data
Mar. 25, 2016 (CN) 201610178665.0

(51) Int. Cl. G06F 3/041

(52) U.S. Cl. CPC G06F 3/0412; G06F 2203/04102

(57) ABSTRACT

Embodiments described herein include devices and methods for receiving detection data from at least one detection module based on a position of a trigger module relative to the at least one detection module. The at least one detection module is arranged in a detection region of the electronic device and the preset detection region and the trigger module are arranged on opposite sides of an electronic device in a bending position. The devices and methods are also for determining the bending position of the electronic device based on the detection data.

### FIELD

The present disclosure relates to the field of electronic devices, and more particularly to an electronic device having a flexible display.

### BACKGROUND

With the development of electronic technology, flexible screens with the advantages of low power consumption and bendability have emerged.

For a conventional electronic device having a flexible screen, the electronic device can be bent, however, a bending position cannot be determined. In other words, a function such as switching an operating state of the electronic device or switching a display screen based on the bending position of the electronic device cannot be realized. This results in the bendability of the electronic device not being fully exploited.

### SUMMARY

One embodiment of the present disclosure includes a method. The method includes receiving detection data from at least one detection module based on a position of a trigger module relative to the at least one detection module. The at least one detection module is arranged in a detection region of the electronic device, and the preset detection region and the trigger module are arranged on opposite sides of an electronic device in a bending position. The method also includes analyzing and determining the bending position of the electronic device based on the detection data.

Another embodiment of the present disclosure includes an electronic device. The electronic device includes a trigger module, at least one detection module, and a processor. The at least one detection module is in a detection region of the electronic device and generates detection data relating to a distance between the detection module and the trigger module. The processor receives the detection data from the at least one detection module and determines a bending position of the electronic device based on the detection data. The detection region and the trigger module are arranged on opposite sides of the electronic device in a bending position.

### BRIEF DESCRIPTION OF THE DRAWINGS

The foregoing and other objects, features and advantages of the present disclosure will become more apparent from the detailed descriptions of the embodiments of the present disclosure in conjunction with the drawings. The drawings are used to provide a further understanding of the embodiments of the present disclosure and constitute a part of the Description, which, together with the embodiments of the present disclosure, serve to explain the present disclosure and are not construed as a limitation to the present disclosure. Unless explicitly indicated, the drawings should not be understood as being drawn to scale. In the drawings, the same reference numerals generally represent the same components or processes. In the drawings:

In order to better illustrate the technical solutions in the embodiments of the present disclosure or in the conventional technology, a brief description for the drawings required for the description of the embodiments or the conventional technology is provided as follows. It should be apparent for those skilled in the art that the drawings in the following description are only for the embodiments of the present disclosure, and other drawings can also be obtained in accordance with the drawings provided without creative work.

FIG. 1 is a flow diagram of one embodiment of an information processing method according to the present disclosure;

FIG. 2A is a schematic arrangement diagram of a detection module and a trigger module in one embodiment of the present disclosure;

FIG. 2B is a schematic arrangement diagram of a detection module and a trigger module in one embodiment of the present disclosure;

FIG. 3 is a flow diagram of one embodiment of an information processing method according to the present disclosure;

FIG. 4 is a flow diagram of one embodiment of an information processing method according to the present disclosure;

FIG. 5 is a flow diagram of one embodiment of an information processing method according to the present disclosure;

FIG. 6 is a schematic diagram showing bending of an electronic device in one embodiment of the present disclosure;

FIG. 7 is a flow diagram of one embodiment of an information processing method according to the present disclosure;

FIG. 8 is a schematic structural diagram of an electronic device in one embodiment of the present disclosure;

FIG. 9 is a flow diagram of one embodiment of an information processing method according to the present disclosure;

FIG. 10 is a schematic structural diagram of an electronic device in one embodiment of the present disclosure;

FIG. 11 is a flow diagram of one embodiment of an information processing method according to the present disclosure;

FIG. 12 is a schematic structural diagram of one embodiment of an electronic device according to the present disclosure.

FIG. 13 is a schematic structural diagram of one embodiment of an electronic device according to the present disclosure.

FIG. 14 is a schematic structural diagram of one embodiment of an electronic device according to the present disclosure.

FIG. 15 is a schematic structural diagram of one embodiment of an electronic device according to the present disclosure.

### DETAILED DESCRIPTION

The technical solution in the embodiments of the present disclosure is described clearly and completely as follows with reference to the drawings in the embodiments of the present disclosure. Obviously, the embodiments described are some, rather than all of the embodiments of the present disclosure. Based on the embodiments of the present disclosure, all other embodiments obtained by those skilled in the art without any creative efforts shall fall within the protection scope of the present disclosure.

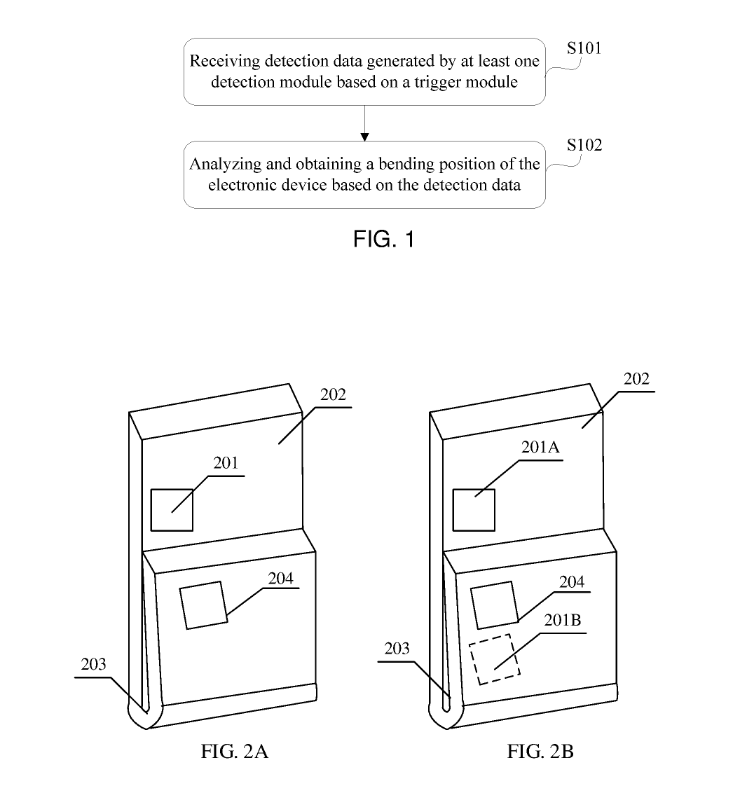

Referring to FIG. 1, which is a flow diagram of one embodiment of an information processing method according to the present disclosure, the information processing method is applicable to an electronic device. Specifically, the electronic device may be in a form such as a desktop, a notebook, a tablet computer, a mobile phone, a smart TV, a smart watch, or a wearable device, and the electronic device is flexible and capable of being bent.

The information processing method includes block S101 and block S102.

At block S101, detection data generated by at least one detection module based on a trigger module is received.

Specifically, in one embodiment, the at least one detection module is arranged in a preset detection region of the electronic device, and the preset detection region and the trigger module are arranged on two sides in a bent position of the electronic device.

It should be noted that there is at least one detection module, and there are two arrangement modes for the detection module and the trigger module: the detection module is arranged on one side of the electronic device in the bent position, and the trigger module is arranged on the other side of the electronic device in the bent position; and the detection module is arranged on two sides of the electronic device in the bent position, and the trigger module is arranged on one side of the electronic device in the bent position.

FIG. 2A illustrates a schematic arrangement diagram of a detection module and a trigger module. In FIG. 2A, an arrangement mode is shown in which a detection module 201A is arranged on one side of an electronic device 202 in a bent position 203. In the illustrated embodiment, the trigger module 204 is arranged on the opposite side of the electronic device 202 from the detection module 201 in the bent position 203. FIG. 2B shows an arrangement mode in which the detection module 201A and 201B is arranged on both sides of the electronic device 202 in the bent position 203. In the illustrated embodiment, the trigger module 204 is arranged on one side of the electronic device 202 in the bent position 203. The second detection module 201B is shown with a dotted line in FIG. 2B to indicate a covered part.

In one embodiment, the detection module generates detection data based on triggering of the trigger module 204. A purpose of block S101 is to receive the detection data in order to determine the bending position.

In block S102, the bending position of the electronic device is analyzed and obtained based on the detection data.

In some embodiments, the detection data characterizes a status of the detection module corresponding to the detection data. In some embodiments, the bending position of the electronic device is analyzed based on the detection data.

In one embodiment, the bending position can be analyzed and obtained based on coordinates of the bending position which can be obtained by acquiring coordinates of the detection module and further based on the length of the electronic device and a position where of the touch module.

In one embodiment, a state of variables associated with the bending position indicates a preset arrangement. For example, a detection module in a first position indicates a first bending state, and a display region corresponding to the first bending state is also preset. Therefore, the display region is directly determined based on these variables. In another embodiment, after it is determined that the electronic device is in a different bending state, a position of a detection module, by which a specific signal is detected, is taken as a boundary of the uncovered area of the display screen.

In some embodiments, the method includes at least one detection module arranged in the preset region of the electronic device having the flexible display screen. The preset detection region and the trigger module are arranged on two sides of the bending position of the electronic device. The method also includes receiving detection data generated by the detection module based on the trigger module and analyzing and obtaining the bending position of the electronic device based on the detection data. In some embodiments, the electronic device has a flexible display screen that has a feature of being bent arbitrarily. When multiple detection modules and the touch module are arranged in the preset detection region of the electronic device, the associated bending position of the electronic device can be determined based on the data detected by the multiple detection modules.

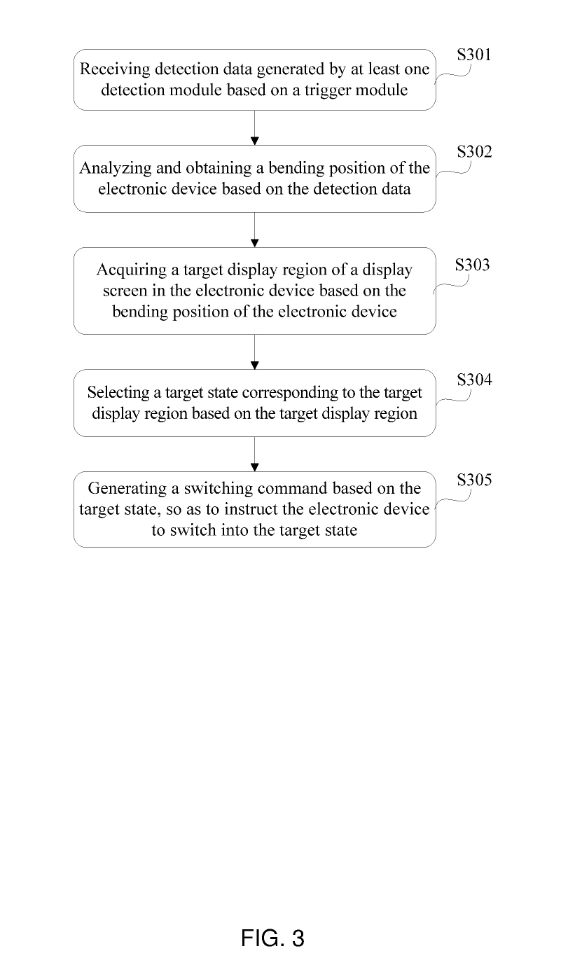

Referring to FIG. 3, which is a flow diagram of one embodiment of an information processing method according to the present disclosure, the method includes blocks S302 to block S305.

In block S301, detection data generated by at least one detection module based on a trigger module is received.

In block S302, a bending position of the electronic device is analyzed and obtained based on the detection data.

In some embodiments, blocks S301-302 are identical to blocks S101-102 above, therefore they are not described repeatedly in this embodiment.

In block S303, a target display region of a display screen in the electronic device is acquired based on the bending position of the electronic device,

In some embodiments, the target display region of the display screen in the electronic device can be analyzed and obtained based on the analyzed and obtained bending position of the electronic device.

In some embodiments, when controlling display in an uncovered region of the display, coordinates of the uncovered region can be calculated based on coordinates of the bending position, the length of the electronic device and a position where the touch module is arranged.

Furthermore, the target display region of the display screen in the electronic device can be determined based on the coordinates of the uncovered region.

In some embodiments, a state of the bending position is preset. For example, a detection module in a first position detects a first bending state, a display region corresponding to the first bending state is also preset which may allow the display region to be determined directly. In other embodiments, after it is determined that the electronic device is in a different bending state, a position of a detection module (which may be determined based on detection of a specific signal) is taken as a boundary of the uncovered area of the display screen.

In block S304, a target state corresponding to the target display region is selected based on the target display region.

In some embodiments, different display regions of the electronic device correspond to different states.

For example, when the target display region is a whole display screen of the electronic device, the electronic device may be in a large screen mode. When the target display region is 0, that is, the display screen in the electronic device is completely covered, the electronic device may be in a standby mode. When the target display region is a small part of the display screen in the electronic device, the electronic device may be in a short message mode. When the target display region is a large part of the display screen in the electronic device, the electronic device may be in a phone mode.

In other embodiments, other target states can be set for different target display regions. Content of the target states is not limited in the present disclosure.

In block S305, a switching command is generated according to the target state. In some embodiments, this is to instruct the electronic device to switch into the target state.

In some embodiments, the electronic device is to be switched into the target state after the target state is selected. In this case, the switching command may be generated based on the target state to control the electronic device and switch into the target state.

It should be noted that in some embodiments, the state of the bending position is determined based on the detection data and then the display region corresponding to the state can be determined directly.

In some embodiments, the information processing method further includes: acquiring a target display region of the display screen of the electronic device based on the bending position of the electronic device; selecting the target state corresponding to the target display region based on the target display region; generating a switching command based on the target state, executing the switching command to switch the electronic device into the target state. In some embodiments of the information processing method, the target display region of the display screen is adjusted based on the bending of the electronic device and the state of the electronic device. The display and an operating state can be adjusted automatically upon detecting the bending. In some embodiments, this allows the current display and operating state to match with a state of the electronic device, thereby improving user experience.

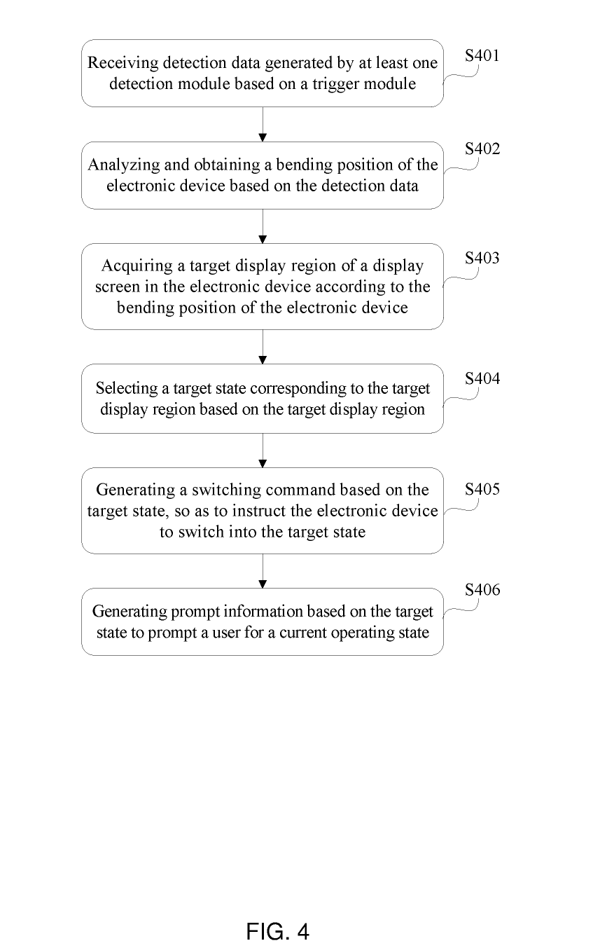

Referring to FIG. 4, which is a flow diagram of one embodiment of an information processing method according to the present disclosure, the information processing method includes blocks S401 to S406.

In block S401, detection data generated by at least one detection module based on a trigger module is received.

In block S402, a bending position of the electronic device is analyzed and obtained based on the detection data.

In block S403, a target display region of a display screen of the electronic device is acquired based on the bending position of the electronic device.

In block S404, a target state corresponding to the target display region is selected based on the target display region.

In block S405, a switching command is generated based on the target state. In some embodiments, the switching command is to instruct the electronic device to switch into the target state.

In some embodiments, blocks S401 to S405 are identical to blocks S301 to S305 described above. For simplicity, they are not described repeatedly in this embodiment.

In block S406, prompting information is generated based on the target state. In some embodiments, the prompting information is to prompt a user for a current operating state.

In some embodiments, after the electronic device is switched into the target state, the user is prompted to communicate to the user that switching the operating state is completed and a new operating state is started.

In some embodiments, the prompt information corresponding to the target state is generated based on the target state.

For example, when the target state is the standby mode, audio prompt information is generated to prompt the user that the electronic device is switched into the standby state.

In some embodiments, the information processing method according to one embodiment of the present disclosure further includes generating prompt information based on the target state to prompt the user with information describing the current operating state. In some embodiments of the information processing method, the user is given a prompt corresponding to switching the operating state. In some embodiments, the prompt is to let the user know that the switching of the operating state is completed, thereby improving user experience.

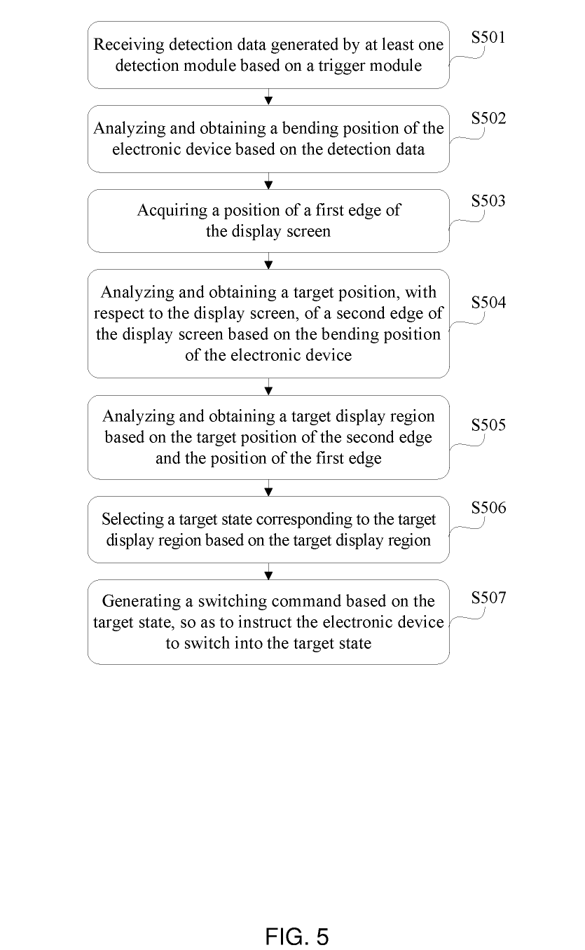

Referring to FIG. 5, which is a flow diagram of one embodiment of an information processing method according to the present disclosure, the information processing method includes block S501 to block S507.

In block S501, detection data generated by at least one detection module based on a trigger module is received.

In block S502, a bending position of the electronic device is analyzed and obtained based on the detection data.

In some embodiments, blocks S301 to S302 are identical to blocks S301 to S302 described above, therefore they are not described repeatedly in this embodiment.

In block S503, a position of a first edge of the display screen is acquired.

In some embodiments, the first edge of the display screen in the electronic device is an edge, parallel to the bending position, of the display screen.

In some embodiments, the first edge is an edge of the display screen physically, which is close to an edge of a face where the display screen in the electronic device is located.

In block S504, a target position, with respect to the display screen, of a second edge of the display screen is analyzed and obtained based on the bending position of the electronic device.

In some embodiments, when the electronic device is bent, the face where the display screen is located is positioned on an inner side of the electronic device. In this arrangement, the target position, with respect to the display screen, of the second edge is a moving boundary of an uncovered region of the display screen.

In some embodiments, a position of the second edge can be calculated based on at least one of coordinates of the bending position of the electronic device, the size of the display screen, a position where the touch module is arranged, etc. Therefore, in some embodiments, the target position, with respect to the display screen, of the second edge in the display screen is obtained.

In block S505, a target display region is analyzed and obtained based on the target position of the second edge and the position of the first edge.

In some embodiments, when the first edge is an edge, relatively far away from the bending position, in the display screen, a region extending from the target position of the second edge to the position of the first edge is the target display region.

In some embodiments, when the first edge is an edge, close to the bending position, in the display screen, a covered part can be analyzed and obtained based on the first edge and the coordinates of the bending position, and the target display region can be further analyzed and obtained based on the size of the display screen.

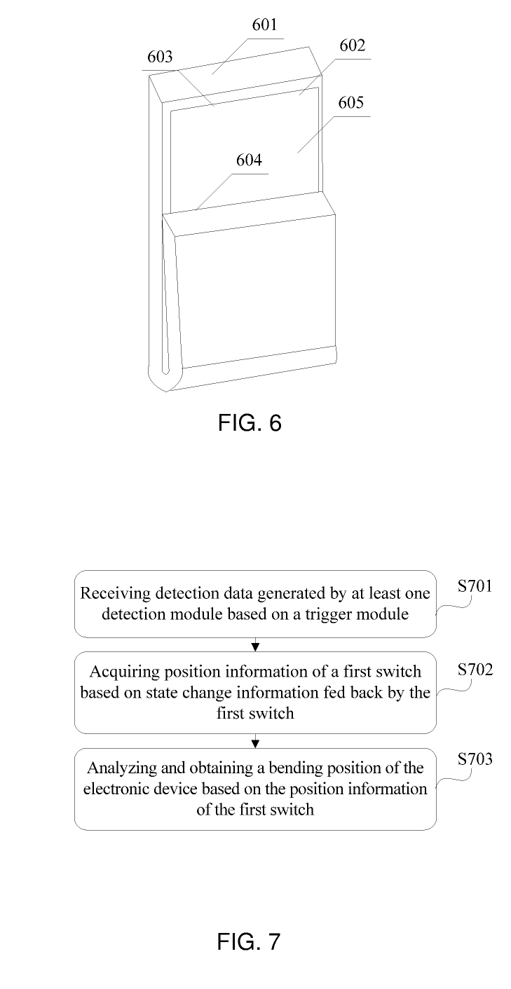

As shown in FIG. 6, which is a schematic diagram for showing bending of the electronic device, the electronic device 601 includes a display screen 602. In some embodiments, the display screen 602 is arranged on a first face of the electronic device. In the illustrated embodiment, the display screen 602 includes a first edge 603 and a second edge 604. In some embodiments, the electronic device bends inward with respect to the face where the display screen 602 is located. In some embodiments, the bending of the electronic device forms a partial region of the display screen 602 which is covered and a target display region 605 of the display screen 602 which is an uncovered region of the display screen 602.

In some embodiments, a correspondence between different bending states and different display regions is preset. In some embodiments, a display region can be determined based on a calculated bending position without complex calculation.

In some embodiments, when the detection module is arranged on an edge of the covered region of the display screen, a position of the detection module, which is detected by a specific signal, is directly taken as a boundary of the uncovered region of the display screen after it is determined that the electronic device is in a different bending state.

For example, a first direction of a long side of the display screen is taken as a coordinate axis, a coordinate of the first edge is 100, a coordinate of the second edge is 50, in this case, the target display region is a region with a length of [50, 100] and a width equal to the width of the display screen.

In another example, when the determined bending position is a first preset position, a position of a detection module by which a specific signal is detected is (20, 50), an axis where the coordinates (20, 50) are located is directly taken as a boundary of the uncovered region of the display screen. Furthermore, since the bending position is also located on an axis, the axis of the bending position is parallel to the axis where the coordinates (20, 50) are located, an edge, relatively far away from the axis, of the display screen in the electronic device is taken as the other boundary of the target display region, and a region between the other boundary and the boundary of the uncovered region of the display screen is the target display region.

In block S506, a target state corresponding to the target display region is selected based on the target display region.

In block S507, a switching command is generated according to the target state, so as to instruct the electronic device to switch into the target state.

In some embodiments, blocks S506 to S507 are identical to blocks S304 to S305 described above, therefore they are not described repeatedly in this embodiment.

In some embodiments, in the information processing method, acquiring the target display region of the display screen in the electronic device is based on the bending position of the electronic device. In some embodiments, acquiring the target display region includes: acquiring the position of the first edge, the first edge is the edge of the display screen that is parallel to the bending position and analyzing and obtaining a target position, with respect to the display screen, of the second edge of the display screen based on the bending position of the electronic device, when the electronic device is bent. In some embodiments, the face where the display screen is located is located on an inner side of the electronic device, and the target position, with respect to the display screen, of the second edge is a moving boundary of an uncovered region of the display screen; and analyzing and obtaining the target display region based on the target position of the second edge and the position of the first edge. In some embodiments of the information processing method, the display region can be analyzed and obtained based on an edge, parallel to the bending position, in the display screen and the moving boundary of the uncovered region of the display screen. The calculation mode is simple and easy to implement.

Referring to FIG. 7, which is a flow diagram of one embodiment of an information processing method according to the present disclosure. In the illustrated embodiment, the information processing method includes block S701 to block S703.

In block S701, detection data generated by at least one detection module based on a trigger module is received.

In some embodiments, block S701, is identical to block S101, described above, for that reason, the embodiments described above are not described repeatedly in this embodiment.

In block S702, a position information of a first switch is acquired according to state change information fed back by the first switch.

In some embodiments, the at least one detection module is a switch array composed of at least one switch, the first switch is any one switch in a preset switch array arranged in the electronic device along a first direction, the first direction is a moving direction of the trigger module when the bending position of the electronic device is changed, and a state of any one switch in the switch array is changed when the any one switch is close to the trigger module.

Since the moving direction of the trigger module can be one or more moving directions of a certain line of the electronic device along two directions, the first direction can be represented to be bidirectional, i.e., bidirectionally extending along a certain straight line.

In some embodiments, state change information are fed back by a switch in the switch array when a state of the switch is changed.

Therefore, the switch, a state of which is changed, can be determined based on the fed back state change information, an identifier of the switch, etc., and an arrangement position of the switch can be further determined.

In some embodiments, an arrangement position and an identifier of each switch are stored in the electronic device. Upon receiving the state change information carrying an identifier, the position of the switch can be determined based on the identifier.

In some embodiments, the switch arrays are arranged in a single row along the first direction.

FIG. 8 is a schematic structural diagram of the electronic device. A switch array is arranged in the electronic device 801 along the first direction. In the illustrated embodiment, FIG. 8 indicates a switch in the detection array. The switch array in FIG. 8 includes four switches 802-805.

In FIG. 8, the first direction is represented as a bidirectional arrow, that is, the bending position of the electronic device can be changed bidirectionally along the first direction.

In block S703, the bending position of the electronic device is analyzed and obtained based on the position information of the first switch.

In some embodiments, after the position information of the first switch, the state of which is changed, is obtained, the bending position of the electronic device can be calculated based on the position coordinates of the first switch, the length of the electronic device, the arrangement position of the trigger module, etc.

In some embodiments of the information processing method, analyzing and obtaining the bending position of the electronic device based on the detection data includes: acquiring the position information of the first switch based on the state change information fed back by the first switch; analyzing and obtaining the bending position of the electronic device based on the position information of the first switch, the first switch is any one switch in a preset switch array arranged in the electronic device along a first direction, the first direction is a moving direction of the trigger module when the bending position of the electronic device is changed, and a state of any one switch in the switch array is changed when the any one switch is close to the trigger module. In some embodiments of the information processing method, the bending position of the electronic device can be calculated by acquiring the position information of the first switch which feeds back the state change information, the calculation mode is simple and easy to implement.

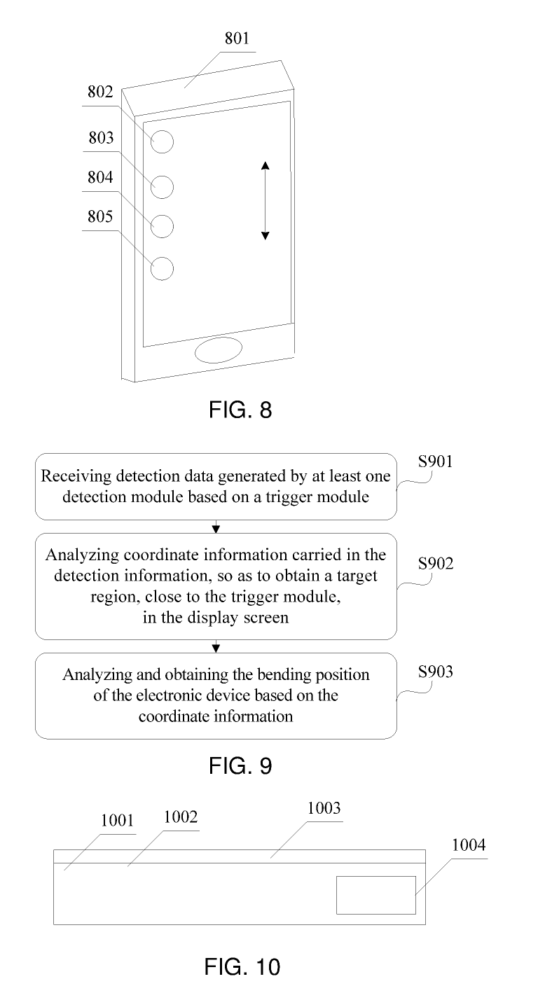

Referring to FIG. 9, which is a flow diagram of one embodiment of an information processing method according to the present disclosure, and the information processing method includes block S901 to block S903.

In block S901, detection data generated by at least one detection module based on a trigger module is received.

In some embodiments, the block S801 is identical to block S101 described above. Therefore, the same embodiments are not described repeatedly here.

In block S902, coordinate information carried in the detection information is analyzed, so as to obtain a target region, close to the trigger module, in the display screen.

In some embodiments, the detection module is a touch detection layer arranged in the display screen of the electronic device, the touch detection layer is arranged on a first face of the electronic device, the first face is located on an inner side of the electronic device when the electronic device is bent, and the coordinate information is outputted when the touch detection layer is close to the trigger module.

In some embodiments, the coordinate information carried in the detection information corresponds to the target region, close to the trigger module, in the display screen.

FIG. 10 is a schematic structural diagram of an electronic device (side view). In the illustrated embodiment, a touch detection layer 1003 is arranged on one side of the display screen 1002 of the electronic device 1001, and the touch detection layer 1003 is arranged on the outer side of the display screen 1002. A trigger module 1004 is arranged in the electronic device.

In block S903, the bending position of the electronic device is analyzed and obtained based on the coordinate information.

In some embodiments, the coordinate information outputted when the touch detection layer is close to the trigger module characterizes a position, close to the trigger module, of the touch detection layer. Due to the position being a position symmetric to the bending position of the electronic device, the bending position of the electronic device may be analyzed and obtained based on the coordinate information carried in the detection information and the length of the electronic device.

In some embodiments of the information processing method, analyzing and obtaining the bending position of the electronic device based on the detection data includes: analyzing the coordinate information carried in the detection information, so as to obtain a target region, close to the trigger module, in the display screen; analyzing and obtaining the bending position of the electronic device based on the coordinate information, the touch detection layer is arranged on a first face of the electronic device, the first face is located on an inner side of the electronic device when the electronic device is bent, and the coordinate information is outputted when the touch detection layer is close to the trigger module. With the information processing method, the bending position of the electronic device can be calculated by acquiring the coordinate information fed back by the touch detection layer of the display screen in the electronic device, the calculation mode is simple and easy to implement.

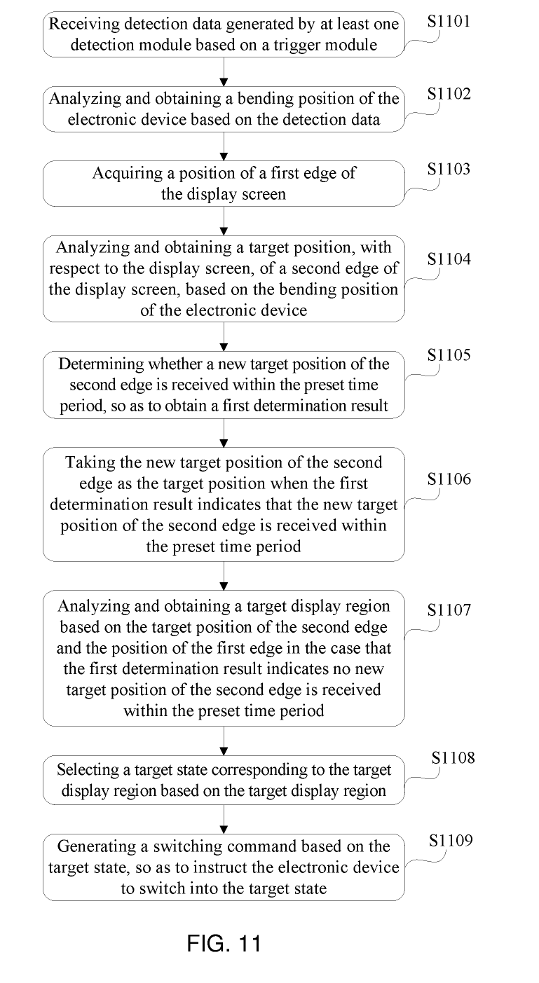

Referring to FIG. 11, which is a flow diagram of one embodiment of an information processing method according to the present disclosure. The information processing method includes block S1101 to block S1109.

In block S1101, detection data generated by at least one detection module based on a trigger module is received.

In block S1102, a bending position of the electronic device is analyzed and obtained based on the detection data.

In block S1103, a position of a first edge of the display screen is acquired.

In block S1104, a target position, with respect to the display screen, of a second edge of the display screen is analyzed and obtained based on the bending position of the electronic device.

In some embodiments, blocks S1101 to S1104 are identical to blocks S501 to S504 described above. Therefore, these embodiments are not described repeatedly here.

In block S1105, it is determined whether a new target position of the second edge is received within the preset time period is determined, so as to obtain a first determination result.

It should be noted that, in some embodiments, the bending position of the electronic device may be changed. The detection data generated by the detection module of the electronic device based on the trigger module may be changed when the electronic device bends. Therefore, the target position of the second edge may be correspondingly changed. Thus, in order to reduce the amount of processed information, the target display region may be determined after the bending position is fixed in this embodiment.

In block S1106, a new target position of the second edge is taken as the target position when the first determination result indicates that a new target position of the second edge is received within the preset time period.

In some embodiments, the preset time period can be a short period of time, such as 1 second or even 50 milliseconds, but it is not limited in this present disclosure.

In some embodiments, when a new target position of the second edge is received within the preset time period, it can be determined that the electronic device is still in a bending process, a new target position of the second edge is used to be taken as a basis for determining the target display region. In some embodiments, when a new target position of the second edge is not received within the preset time period, it can be determined that the bending position of the electronic device is fixed.

In block S1107, when the first determination result indicates that no new target position of the second edge is received within the preset time period, the target display region is analyzed and obtained based on the target position of the second edge and the position of the first edge.

In block S1108, a target state corresponding to the target display region is selected based on the target display region.

In block S1109, a switching command is generated based on the target state, so as to instruct the electronic device to switch into the target state.

In some embodiments, blocks S1107 to S1109 are identical to blocks S505 to S507 described above. Therefore, these embodiments are not described repeatedly here.

In some embodiments, the information processing method further includes: determining whether a new target position of the second edge is received within the preset time period, so as to obtain a first determination result; taking the new target position of the second edge as the target position when the first determination result indicates a new target position of the second edge is received within the preset time period; and analyzing and obtaining the target display region based on the target position of the second edge and the position of the first edge when the first determination result indicates that no new target position of the second edge is received within the preset time period. With the information processing method, whether the bending process is over may be determined by determining whether a new target position of the second edge is received within the preset time period, thus the method is simple and easy to be implement and has a small amount of data processing.

An information processing method is described in detail in the embodiments of the present disclosure mentioned above. Multiple types of devices may be used to realize the information processing method according to the present disclosure. Therefore, an electronic device into which the information processing method is applied is further provided in the present disclosure, the electronic device is described in detail in specific embodiments below.

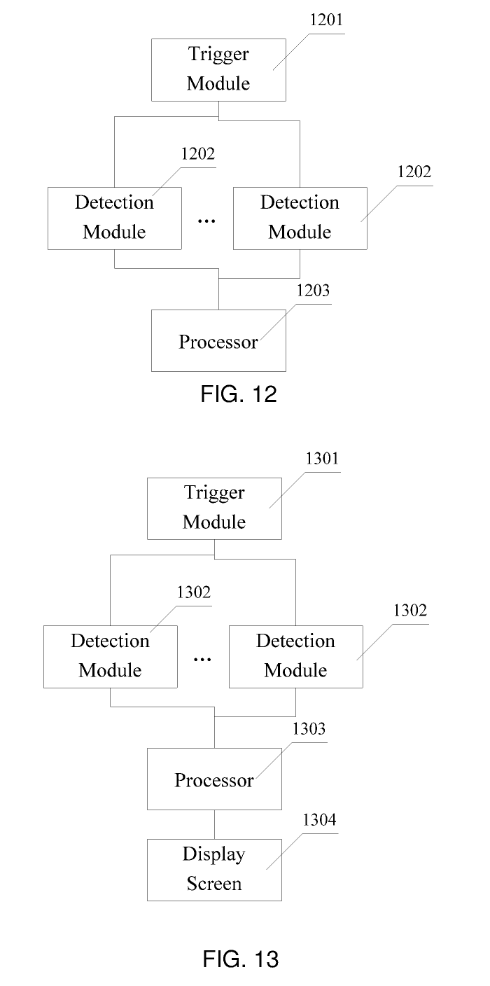

Referring to FIG. 12, which is a schematic structural diagram of one embodiment of an electronic device according to the present disclosure. The electronic device may be in a form such as a desktop, a notebook, a tablet computer, a mobile phone, a smart TV, a smart watch, or a wearable device, and the electronic device is flexible and capable of being bent.

The illustrated embodiment of the electronic device includes: a trigger module 1201, at least one detection module 1202 and a processor 1203.

In some embodiments, at least one detection module 1202 is configured to generate detection data, and the detection data is used for characterizing whether a distance between the detection module and the trigger module is less than a preset value.

In some embodiments, when the distance between the detection module and the trigger module is less than a preset value, the detection module can generate detection data for notifying that the distance is less than the value.

The processor 1203 is configured to: receive the detection data from the at least one detection module, the at least one detection module is distributed in a preset region of the electronic device; analyze and obtain a bending position of the electronic device based on the detection data.

In some embodiments, the preset detection region and the trigger module are arranged on two sides of the bending position of the electronic device.

It should be noted that, in some embodiments, a way of arrangement for the detection module and the trigger module refers to FIG. 2, therefore they are not described repeatedly here.

In some embodiments of the electronic device, since that the electronic device has the flexible display screen and a feature of being bent arbitrarily, when multiple detection modules and the touch module are arranged in the preset detection region of the electronic device, the bending position of the electronic device can be determined based on the data detected by the multiple detection modules.

Referring to FIG. 13, which is a schematic structural diagram of one embodiment of an electronic device according to the present disclosure. In the illustrated embodiment, the electronic device includes: a trigger module 1301, at least one detection module 1302, a processor 1303 and a display screen 1304.

The trigger module 1301, the at least one detection module 1302, and the processor 1303 may have the same functions as those in other embodiments. Therefore, those embodiments are not described repeatedly here.

In some embodiments, the display screen 1304 is configured to display a target display content.

The processor 1303 may further be configured to: acquire a target display region of the display screen in the electronic device based on the bending position of the electronic device; select a target state corresponding to the target display region based on the target display region; and generate a switching command based on the target state, so as to instruct the electronic device to switch into the target state.

In some embodiments, different display regions in the electronic device correspond to different states.

For example, when the target display region is a whole display screen of the electronic device, the electronic device may be in a large screen mode. When the target display region is 0, that is, the display screen in the electronic device is completely covered, the electronic device may be in a standby mode. When the target display region is a small part of the display screen in the electronic device, the electronic device may be in a short message mode. When the target display region is a large part of the display screen in the electronic device, the electronic device may be in a phone mode.

In other embodiments, other target states can be set for different target display regions. Content of the target states is not limited in the present disclosure.

In some embodiments of an electronic device, the target display region of the display screen can be adjusted based on the bending of the electronic device, and the state of the electronic device can be further adjusted. The state of the electronic device may be switched by simply bending, and the operation is simple and easy to implement.

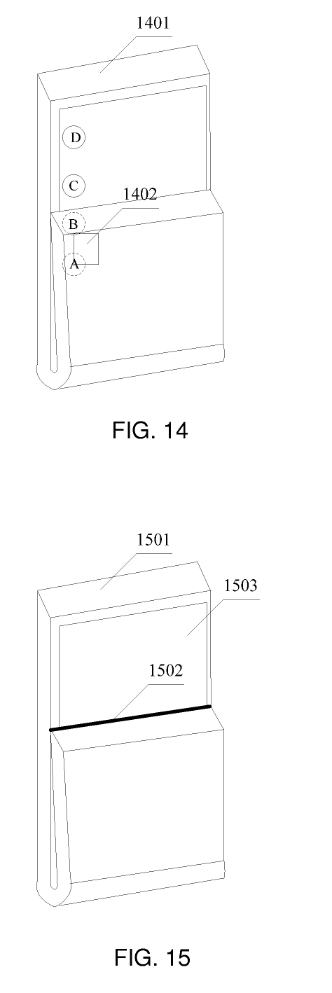

Referring to FIG. 14, which is a schematic structural diagram of one embodiment of an electronic device according to the present disclosure. The illustrated embodiment of the electronic device 1401 includes: a trigger module 1402, at least one detection module 1403, and a processor 1404.

In some embodiments, the at least one detection module is a switch array composed of at least one switch. In some embodiments, the switch array is arranged along a first direction of the electronic device, and a state of any one switch in the switch array is changed when the any one switch is close to the trigger module.

In some embodiments, the trigger module is arranged on an edge, along a first direction, in the electronic device.

FIG. 14 shows a schematic structural diagram of the electronic device in a bending state. The illustrated embodiment of the trigger module 1402 is arranged on one end of the electronic device 1401, and a switch array is arranged in the electronic device 14 along the first direction. In FIG. 14, the illustrated embodiment indicates a switch in the detection array, and the switch array in FIG. 14 includes four switches A, B, C and D, the trigger module 1402 is close to the switch B. A dotted line in FIG. 14 indicates a covered part.

In some embodiments, when the trigger module 1402 is close to the switch B, the switch B feeds back the detection data generated when the trigger module is close to the switch B.

In other embodiments, when different ways of bending correspond to different target states, the number of switches corresponding to the way of bending can be arranged

In some embodiments, the trigger module can be a magnet, which can generate a magnetic field. A Hall switch may be used in the detection module, an on/off state of the Hall switch can be changed based on a change in the magnetic field, that is, the on/off state of the Hall switch can be reversed when the magnet is close to the Hall switch.

In some embodiments of the electronic device, the trigger module is arranged on an edge, along a first direction, in the electronic device, and the first direction is a moving direction of the trigger module when the bending position of the electronic device is changed. The at least one detection module may be the switch array composed of at least one switch. In some embodiments, the switch array is arranged along a first direction of the electronic device, and the state of any one switch in the switch array is changed when the any one switch is close to the trigger module. With embodiments of this electronic device, the bending position of the electronic device can be calculated by acquiring position information of a first switch which feeds back the state change information, thus the way of calculation is simple and easy to implement.

Referring to FIG. 15, which is a schematic structural diagram of one embodiment of an electronic device according to the present disclosure. The illustrated embodiment of the electronic device 1501 includes: a trigger module 1502, at least one detection module 1503, and a processor 1504.

The illustrated embodiment of the at least one detection module 1503 is a touch detection layer arranged on a display screen of the electronic device in a laminated manner.

The touch detection layer may be arranged on a first face of the electronic device. In some embodiments, the first face is located on an inner side of the electronic device when the electronic device is bent, and coordinate information is outputted when the touch detection layer is close to the trigger module.

In some embodiments, the trigger module can be formed by a conductive material arranged on an edge of the first face of the electronic device.

FIG. 15 shows a schematic structural diagram of an electronic device in a bending state. The illustrated embodiment of the trigger module 1502 is a conductive material arranged on one edge of the electronic device 1501, and the detection module 1503 is the touch detection layer arranged on a surface of the display screen in a laminated manner. In some embodiments, when the trigger module 1502 is close to the display screen/the touch detection layer, the touch detection layer feeds back the coordinate information outputted when the trigger module is close to the touch detection layer. A dotted line in FIG. 15 indicates a covered part.

In some embodiments, a way of arrangement for the touch detection layer and the display screen is as shown in FIG. 10, therefore it is not described repeatedly here.

In some embodiments of the electronic device, the at least one detection module is the touch detection layer arranged on the display screen of the electronic device in a laminated manner. The touch detection layer may be arranged on a first face of the electronic device. The first face may be located on an inner side of the electronic device when the electronic device is bent. In some embodiments, the coordinate information is outputted when the touch detection layer is close to the trigger module. In some embodiments of this electronic device, the bending position of the electronic device can be calculated by acquiring the coordinate information fed back by the touch detection layer of the display screen in the electronic device, thus the way of calculation is simple and easy to implement.

Various embodiments in the present disclosure are described in a progressive manner, with the emphasis of each of the embodiments on the differences between it and the other embodiments, hence, for the same or similar parts between the embodiments, one can refer to the other embodiments. For the devices provided in the embodiments, the description thereof is simple since they correspond to the methods provided in the embodiments. Please refer to the description of the methods disclosed in the embodiments, hence one can refer to the description of the methods portion for related parts.

Those skilled in the art can implement or use the disclosure based on the above description of the embodiments. Various modifications made to these embodiments are apparent to those skilled in the art. General principles defined herein can be implemented in other embodiments without departing from the spirit or scope of the present disclosure. Therefore, the present disclosure is not to be limited to the embodiments disclosed herein, but is to be accorded with the broadest scope consistent with the principles and novel features provided herein.

What is claimed is:

1. A method comprising:
receiving detection data from at least one detection module based on a position of a trigger module relative to the at least one detection module, wherein the at least one detection module is arranged in a detection region of the electronic device, and the detection region and the trigger module are arranged on opposite sides of an electronic device in a bending position;
determining the bending position of the electronic device based on the detection data.

2. The method according to claim 1, further comprising:
designating a target display region on a display screen of the electronic device based on the bending position of the electronic device;
selecting a target display state corresponding to the target display region; and
generating a switching command to instruct the electronic device to switch to the target display state.

3. The method according to claim 2, wherein acquiring the target display region on the display screen of the electronic device comprises:
acquiring a position of a first edge of the display screen, wherein the first edge is an edge of the display screen that is parallel to a bend in the display screen;
determining a target position of a second edge of the display screen in the bending position of the electronic device, wherein the display screen is located on an inner side of the bend in the electronic device and the target position of the second edge of the display screen forms a moveable boundary of an uncovered region of the display screen; and
determining the target display region based on the target position of the second edge and the position of the first edge.

4. The method according to claim 1, wherein the at least one detection module is a switch array comprising at least one switch, and wherein determining the bending position of the electronic device comprises:
acquiring position information of a first switch based on state change information from the first switch; and
determining the bending position of the electronic device based on the position information of the first switch, wherein the first switch is at least one switch in a switch array arranged in the electronic device along a first direction, the first direction defined by a direction of movement of the trigger module in response to a change in the bending position of the electronic device, and wherein a state of any switch in the switch array is changed in response to a determination that the first switch is proximate the trigger module.

5. The method according to claim 1, wherein the at least one detection module comprises a touch detection layer arranged in the display screen of the electronic device on a first face located on an inner side of the electronic device when the electronic device is bent, and wherein determining the bending position of the electronic device based on the detection data comprises:
analyzing coordinate information extracted from the detection information to obtain a target region of the display screen; and
determining the bending position of the electronic device based on the coordinate information, wherein the touch detection layer is arranged and
outputting the coordinate information in response to a determination that the touch detection layer is proximate the trigger module.

6. The method according to claim 3, wherein determining the target position of the second edge of the display screen based on the bending position of the electronic device further comprises:
generating a first determination result in response to detection of a new target position of the second edge of the display screen within a preset time period;
updating the target position of the second edge to the new target position of the second edge in response to receipt of the first determination result; and
determining the target display region based on the target position of the second edge and the position of the first edge in response to detection that the first determination result indicates that no new target position of the second edge is received within the preset time period.

7. The method according to claim 2, wherein generating the switching command further comprises:
generating prompt information based on the target state to communicate a current operating state of the electronic device.

8. An electronic device, comprising:
a trigger module;
at least one detection module in a detection region of the electronic device that generates detection data relating to a distance between the detection module and the trigger module; and
a processor that receives the detection data from the at least one detection module and determines a bending position of the electronic device based on the detection data;
wherein the detection region and the trigger module are arranged on opposite sides of the electronic device in a bending position.

9. The electronic device according to claim 8, further comprising:
a display screen that displays a target display content;
wherein the processor is further configured to:
acquire a target display region of the display screen of the electronic device based on the bending position of the electronic device;
select a target display state based on the target display region; and
generate a switching command based on the target display state to switch the electronic device into the target display state.

10. The electronic device according to claim 8, wherein
the at least one detection module is a switch array comprising at least one switch, wherein the switch array is arranged along a first direction of the electronic device and a state of any one switch in the switch array is changed in response to a determination that the any one switch is proximate to the trigger module; and
the trigger module is arranged on an edge of the electronic device.

11. The electronic device according to claim 8, wherein
the at least one detection module comprises a touch detection layer arranged on the display screen of the electronic device in a laminated arrangement on a first face of the electronic device, the first face being located on an inner side of the electronic device when the electronic device is bent, and
coordinate information is outputted in response to a determination that the touch detection layer is proximate the trigger module.
